(19) United States
(12) Patent Application Publication
(10) Pub. No.: US 2008/0179235 A1
(43) Pub. Date: Jul. 31, 2008

(54) Fluid Filter Arrangement and Method

(76) Inventors: John R. Hacker, Edina, MN (US); Gus E. Brieland, Minneapolis, MN (US); Randall William Heibenthal, Mahomet, IL (US); Dennis Michael Deedrich, Champaign, IL (US); David P. Welzant, Bloomington, MN (US); Thomas A. Boeckermann, Lakeville, MN (US)

Correspondence Address: MERCHANT & GOULD PC, P.O. BOX 2903, MINNEAPOLIS, MN, 55402-0903, US

(21) Appl. No.: 11/718,642

(22) PCT Filed: Oct. 31, 2005
(86) PCT No.: PCT/US05/39429

§ 371 Date: Nov. 29, 2007

Related U.S. Application Data
(60) Provisional application No. 60/625,504, filed on Nov. 5, 2004.
(60) Provisional application No. 60/657,496, filed on Mar. 1, 2005.

(51) Int. Cl. B01D 29/15; B01D 65/02; B01D 29/96; B01D 35/153; B01D 35/16

(52) U.S. Cl. 210/232; 210/450; 210/636

(57) ABSTRACT

A filter cartridge is provided including a media pack, a valve arrangement, and first and second seal members. The seal members have different release forces associated with them. In one implementation, the different release forces are provided by having differing outermost dimensions (diameter, if circular). One of the seal members can be larger than the other seal member. In some arrangements, the relationship between the outermost dimension of the first seal member is 1.5 times the size of the outermost dimension of the second seal member. In another aspect, the disclosure provides a filter assembly including a filter bowl and a removable and replaceable filter cartridge operably mounted in the bowl. The filter cartridge includes a media pack, a valve arrangement, and a seal member forming a seal between the filter bowl and the filter cartridge. The seal blocks fluid flow from the interior of the filter bowl through a drain port defined by the filter bowl. In another aspect, the disclosure provides for a method of servicing a filter assembly. The method includes removing a filter bowl from a filter head to, first, release a seal between the filter bowl and the filter cartridge to open a drain port in the filter bowl. Next, fluid is drained from the filter bowl through the drain port. Next, the user continues to remove the filter bowl from the filter head to, second, release a seal between the filter cartridge and the filter head.

This application is being filed on 31 October 2005, as a PCT International Patent application in the name of Donaldson Company, Inc., a U.S. national corporation, applicant for the designation of all countries except the US, and John R. Hacker, Gus E. Breiland, Randall William Hiebenthal, Dennis Michael Deedrich, David P. Welzant, and Thomas A. Boeckermann, all citizens of the U.S., applicants for the designation of the US only, and claims priority to U.S. Provisional Application Ser. Nos. 60/625,504, filed Nov. 5, 2004, and 60/657,469, filed Mar. 1, 2005.

### TECHNICAL FIELD

This disclosure relates to filter assemblies, in particular, filter assemblies for purifying fluids, such as liquid. In certain aspects, this disclosure relates to filtration assemblies for hydraulic, oil, and fuel systems. The disclosure is particularly concerned with cartridge filter assemblies.

### BACKGROUND

Filters are commonly used in connection with lubrication systems and fuel systems for internal combustion engines, and hydraulic systems for heavy-duty equipment. Filters are often used in many other types of liquid systems. In these types of systems, the filter is changed periodically.

One type of filter assembly that is typically used is a bowl-cartridge filter assembly. Bowl-cartridge filter assemblies typically include a reusable bowl holding a replaceable filter element (cartridge filter). Bowl-cartridge filters mount onto a filter head, wherein the fluid (usually liquid) to be cleaned passes through the filter head, into the bowl, through the replaceable cartridge filter, outside of the bowl and back into the filter head. After a period of use, the bowl-cartridge filter is removed from the filter head and the replaceable cartridge filter is removed from the reusable bowl. The old cartridge filter is discarded and replaced with a new cartridge filter. The new cartridge filter is operably mounted into the reusable bowl to provide a refurbished bowl-cartridge filter. This refurbished bowl-cartridge filter, containing the new cartridge filter, is then mounted onto the filter head.

Disposal of the liquid in the filter bowl, as well as disposal of the cartridge filter, presents issues. The person servicing the bowl-cartridge filter assembly does not wish to come into contact with the liquid or with the used cartridge filter. Improvements are desirable.

### SUMMARY OF THE DISCLOSURE

A filter cartridge is provided including a media pack, a valve arrangement, and first and second seal members. The seal members have different separation forces. For example, the seal members can be of differing outermost dimensions (diameter, if circular). One of the seal members can be larger than the other seal member. In some arrangements, the relationship between the outermost dimension of the first seal member is 1.5 the size of the outermost dimension of the second seal member.

In another aspect, the disclosure provides a filter assembly including a filter bowl and a removable and replaceable filter cartridge operably mounted in the bowl. The filter cartridge includes a media pack, a valve arrangement, and a seal member forming a seal between the filter bowl and the filter cartridge. The seal blocks fluid flow from the interior of the filter bowl through a drain port defined by the filter bowl.

In another aspect, the disclosure provides for a method of servicing a filter assembly. The method includes removing a filter bowl from a filter head to, first, release a seal between the filter bowl and the filter cartridge to open a drain port in the filter bowl. Next, fluid is drained from the filter bowl through the drain port. Next, the user continues to remove the filter bowl from the filter head to, second, release a seal between the filter cartridge and the filter head.

### BRIEF DESCRIPTION OF THE DRAWINGS

FIG. 1 is a perspective view of a filter assembly constructed according to principles of this disclosure;

FIG. 2 is an exploded, perspective view of the filter assembly depicted in FIG. 1;

FIG. 3 is another exploded, perspective view of the filter assembly depicted in FIG. 1;

FIG. 4 is a perspective view of a filter cartridge used in the filter assembly depicted in FIGS. 1-3;

FIG. 5 is another perspective view of the filter cartridge depicted in FIG. 4;

FIG. 6 is an enlarged, perspective view of a valve arrangement used with the filter cartridge of FIGS. 4 and 5;

FIG. 7 is a top, plan view of the filter assembly depicted in FIG. 1;

FIG. 8 is a schematic, cross-sectional view of the filter assembly depicted in FIG. 1, the cross-section being taken along the line 8-8 of FIG. 7;

FIG. 9 is an enlarged view of a portion of the cross-section depicted in FIG. 8;

FIG. 10 is another schematic, cross-sectional view of the filter assembly of FIG. 1, the view in FIG. 10 showing the bowl and filter cartridge being dismounted from the filter head;

FIG. 11 is an enlarged view of a portion of the cross-section depicted in FIG. 10;

FIG. 12 is a bottom plan view of the filter bowl and filter cartridge dismounted from the filter head;

FIG. 13 is a schematic, cross-sectional view of the filter bowl and filter cartridge depicted in FIG. 12, the cross-section being taken along the line 13-13 of FIG. 12;

FIG. 14 is an enlarged view of a portion of the cross-section depicted in FIG. 13, and showing the filter cartridge being dismounted from the filter bowl;

FIG. 15 is a schematic, cross-sectional view showing the mounting and operable assembly of a replacement part filter cartridge into the filter bowl;

FIG. 16 is an enlarged view of a portion of the cross-section depicted in FIG. 15;

FIG. 17 is a schematic depiction of a piece of equipment having an engine utilizing a filter assembly of the type depicted in FIGS. 1-16;

FIG. 18A is a schematic, cross-sectional view of a second embodiment of a filter assembly, analogous to the view shown in FIG. 8;

FIG. 18B is an enlarged view of a portion of the cross-sectional view of the filter assembly depicted in FIG. 18A;

FIG. 18C is a schematic, perspective view of an end cap used in the filter assembly depicted in FIGS. 18A and 18B;

FIG. 18D is an enlarged view of a portion of the end cap depicted in FIG. 18C;

FIG. 19 is a fragmented, schematic, cross-sectional view of another embodiment of a filter assembly;

FIG. 20 is a schematic, cross-sectional, fragmented view of the filter assembly depicted in FIG. 19, and showing the filter cartridge being dismounted from the filter bowl, similar to the view shown in FIG. 14;

FIG. 21 is a schematic, perspective view of another embodiment of a filter cartridge useable in filter assemblies depicted herein;

FIG. 22 is another perspective view of the filter cartridge depicted in FIG. 21;

FIG. 23 is a schematic, cross-sectional view of a filter assembly with the filter cartridge of FIGS. 21 and 22 installed therein; and

FIG. 24 is a schematic, cross-sectional view of an alternative embodiment of a filter assembly, with portions broken away, constructed according to principles of this disclosure.

### DETAILED DESCRIPTION

FIG. 17 is a schematic depiction of equipment 10 including an engine 12. The equipment 10 includes a lubrication system 14, a fuel system 15, and a hydraulic system 16. The lubrication system 14, the fuel system 15, and the hydraulic system 16 will need to have a fluid in the system (oil, fuel, or hydraulic fluid) cleaned. To provide the cleaning function, a fluid filter assembly is utilized. In the example embodiment shown in FIG. 17, there are three fluid filter assemblies 20 shown, one for the lubrication system 14, one for the fuel system 15, and one for the hydraulic system 16. Equipment 10 shown in FIG. 17 is a tractor 18. The fluid filter assembly 20 is useable with other types of equipment including bulldozers, skid steers, payloaders, mining equipment, over-the-highway trucks, off-road trucks, combines, and other types of equipment. Other types of equipment include industrial filtration devices, generators, and any system with an engine or hydraulic system.

For the systems described herein, mobile hydraulic filters will have operating pressures generally between −7 psi and 700 psi. Operating pressures for an engine lube system will be 40 psi −80 psi, with compressor lube systems being about 250 psi. For fuel systems, if the pressure is on the upstream side of the pump, it will be under vacuum pressure of about −10 psi. If used as a secondary filter, on the downstream side of the pump, the operating pressures will be 60 psi. In industrial hydraulic applications, the pressures are generally high, such as up to 6,000 psi. Of course, the pressures can vary, and these are merely examples.

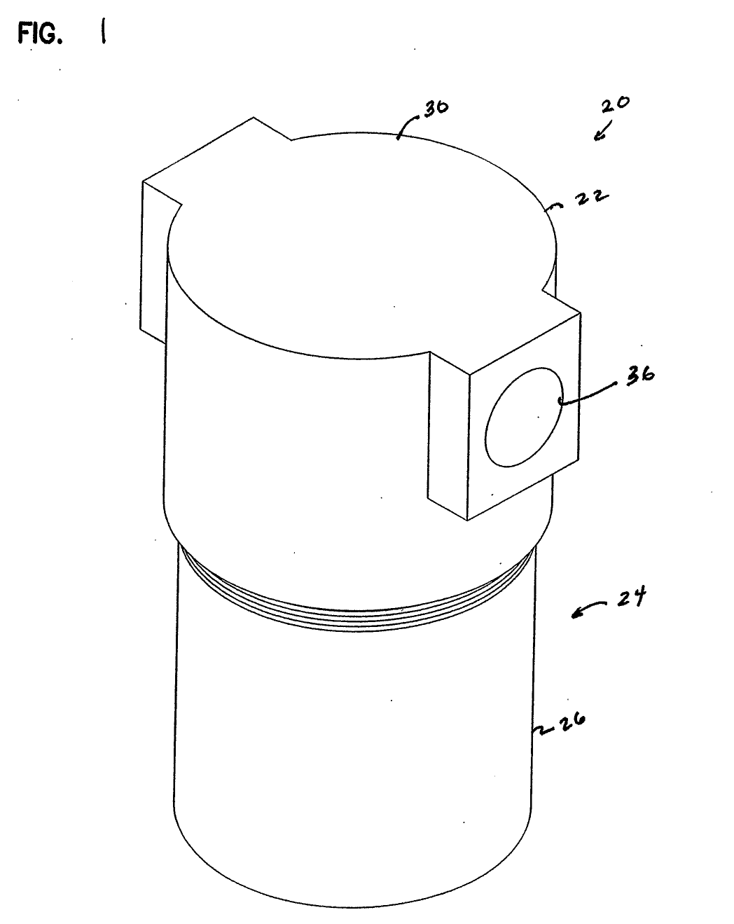

Attention is now directed to FIGS. 1-5. An embodiment of the fluid filter assembly 20 is illustrated in perspective view in FIGS. 1-3. The fluid filter assembly 20 depicted includes a filter head 22 and a bowl-cartridge filter 24. The filter head 22 is typically positioned in fluid systems such that the fluid is directed from the system by the filter head 22 and through the bowl-cartridge filter 24.

By the term “bowl-cartridge filter”, it is meant a filter having a reusable housing or bowl holding a replaceable cartridge filter (interchangeably known herein as a filter element or filter cartridge). After a period of use, when the filter cartridge becomes clogged or restriction increases to an unacceptable level, the bowl-cartridge filter is serviced. By “serviced” or variants thereof, it is meant that the bowl-cartridge filter is removed from the filter head, the filter cartridge is removed from the bowl, and a new filter cartridge is installed with the bowl. The bowl with the new filter cartridge is then mounted onto the filter head.

The filter head 22 is constructed for operable receipt or mounting of the bowl-cartridge filter 24. By “operable receipt or mounting” and variants thereof, it is meant that the filter head 22 includes appropriate structure for engaging the bowl-cartridge filter 24, such that fluid to be cleaned is directed through the appropriate channels and is cleaned as intended.

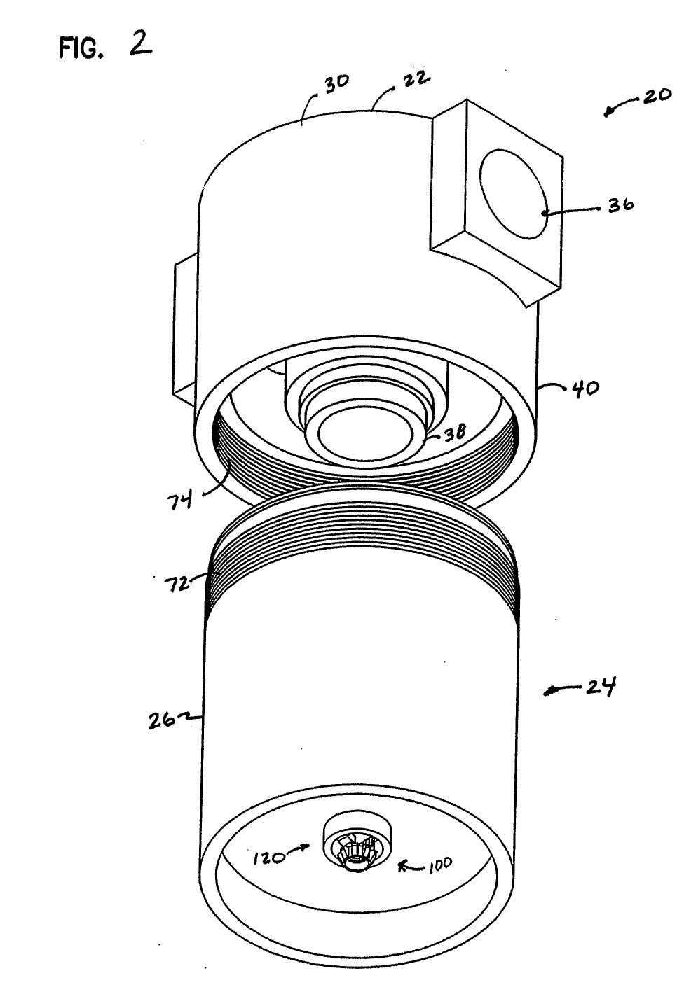

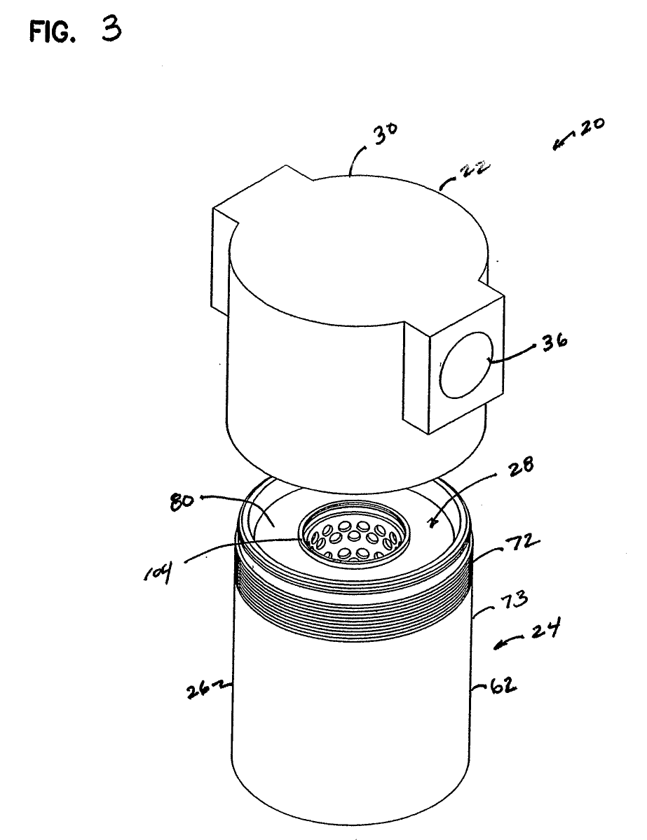

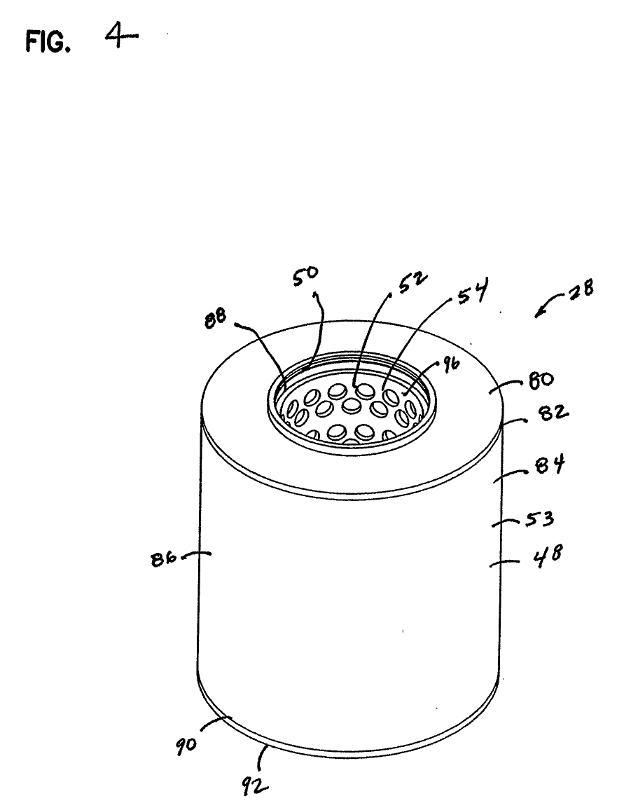

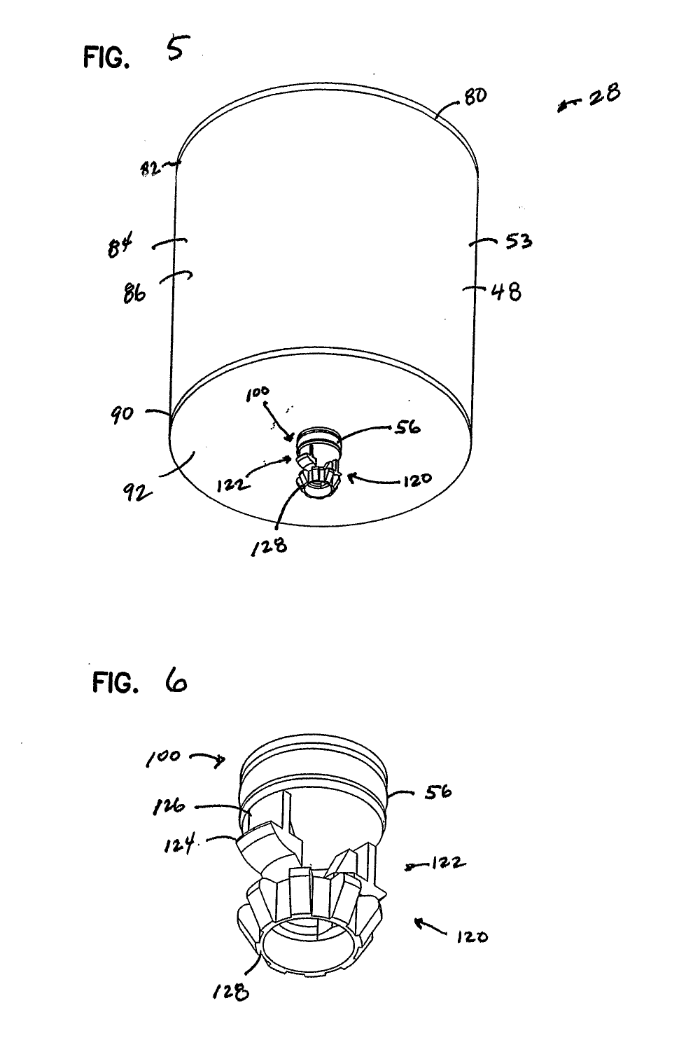

FIGS. 2 and 3 show the bowl-cartridge filter removed from the filter head 22. The bowl-cartridge filter 24 includes a reusable housing or bowl 26 operably holding a removable and replaceable filter cartridge 28. FIGS. 4 and 5 show the filter cartridge 28 in alternate perspective views.

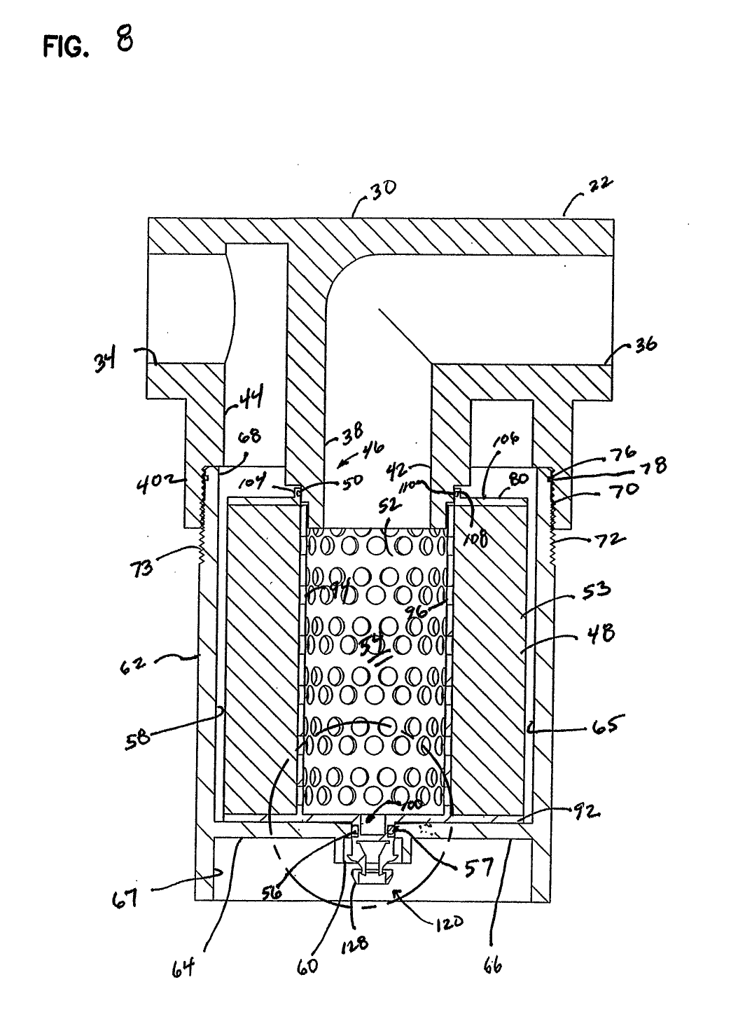

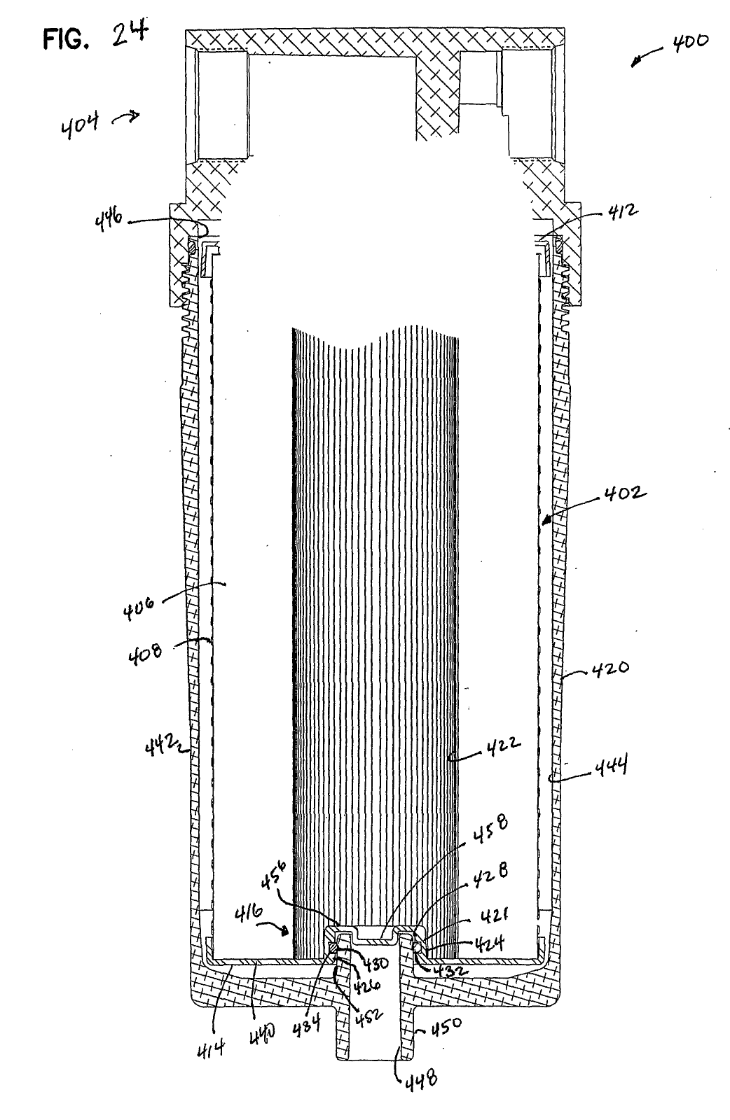

The filter head 22 includes a block 30 defining channels 32 in order to allow for the inflow and outflow of fluid to be directed into the bowl-cartridge filter 24. The filter head 22 may be configured for either a forward flow system or reverse flow system. By “forward flow”, it is meant that fluid to be cleaned flows from outside of the filter element, through the media, and into an interior portion of the filter element. By “reverse flow”, it is meant that the fluid to be cleaned flows from the interior of the filter element, through the media, and to the outside of the filter element. In one example embodiment, the filter head 22 is configured for forward flow. As such, the filter block 30 defines an inlet port 34, an outlet port 36, and an interior or center tube or spud 38 (FIG. 8). The center spud 38 is circumscribed by an outer wall 40 of the block 30. The spud 38 defines an outflow channel 42 that begins in the interior of the bowl-cartridge filter 24 and ends at the outlet port 36. The inlet port 34 is in fluid flow communication with an inlet channel 44. The inlet channel 44 is depicted in FIG. 8 as at least partially surrounding the spud 38. A reverse flow system is shown in FIG. 23, described below.

A seal arrangement 46 helps to contain fluid from bypassing a region of filter media 48 within the filter cartridge 28. In the embodiment shown, the seal arrangement 46 includes a first seal member 50 located between the spud 38 and a portion of the filter cartridge 28. The seal member 50 prevents fluid from passing from the inlet channel 44 into a clean liquid volume 52 and into the inflow channel 42, without passing through the filter media 48 first. In the embodiment shown, the filter media 48 is a tubular construction 53, for example, cylindrical, defining an open interior volume 54. The open interior volume 54 corresponds to the clean (or filtered) fluid volume 52, while region 65 corresponds to an uncleaned (or unfiltered) fluid volume the because the fluid that is within the region 54 could not have gotten to that location without first passing through the filter media 48.

A second seal member 56 is positioned between the filter cartridge 28 and the filter bowl 26. This second seal member 56 creates a seal 57 in order to prevent the unintended passage of fluid from an interior volume 58 in the bowl 26 through a drain port 60 defined by the bowl 26.

The housing or bowl 26 has a continuous, exterior side wall 62 that defines the interior volume 58. There is a bottom wall 64 forming a closed end 66. The closed end 66 defines an opening, or the drain port 60, providing fluid communication with the interior volume 58 of the bowl 26, when the seal 57 is released between the filter cartridge 28 and the bowl 26. At the end opposite to the closed end 66, the bowl 26 defines a mouth or opening 68 for receipt of the filter cartridge 28. The side wall 62 of the filter bowl 26 circumscribes the bottom wall 64 and defines two regions. A first region 65 corresponds to the interior volume 58 of the filter bowl 26 for operably housing or holding the filter cartridge 28. A second region 67 is on an opposite side of the bottom wall 64 than the first region 65.

The filter bowl 26 and the filter head 22 are removably connectable or fastenable to each other. In the illustrated embodiment, the filter head 22 and filter bowl 26 are fastened together by way of a threaded connection 70. In FIG. 8, the filter bowl 26 can be seen to define threads 72 on an exterior portion 73 of the side wall 62 circumscribing the mouth 68. Mating threads 74 are directed internally along the outer wall 40 of the filter head 22. A seal member 76 forms a seal 78 between the filter bowl 26 and filter head 22.

Turning to FIGS. 4 and 5, the filter cartridge 28, in the illustrated embodiment, includes a first end cap 80. The first end cap 80 is secured to a first end 82 of a media pack 84. The media pack 84 includes the filter media 48. A variety of filter media 48 can be used in the media pack 48. In the illustrated embodiment, the media pack 84 includes pleated media 86. The pleated media 86 is arranged in a tubular form, such as a cylinder. In certain embodiments, the pleated media 86 will be pleated paper or pleated cellulose.

The first end cap 80 defines a first end cap aperture 88 which is in fluid communication with the clean liquid volume 52. The clean liquid volume 52 corresponds to the open interior volume 54 defined by the tubular construction 53 of the filter media 48. Note that, in the embodiment illustrated, the aperture 88 is open and continuously unplugged. By “continuously unplugged”, it is meant that it is never completely closed. Also, note that the first end cap 80 and its adjacent vicinity is free of any service cover engagement hooks.

The media pack 84 includes a second end 90, opposite of the first end 82. Adjacent to the second end 90 is a second end cap 92. In preferred embodiments, the second end cap 92 is secured to the second end 90 of the media pack 84. Preferably, the media pack 84 extends and is secured to the first end cap 80 at the first end 82, and the second end cap 92 at the second end 90.

In the embodiment illustrated, the media pack 84 is internally supported by a filter support 94. In the FIGS., the filter support 94 is depicted as an inner, tubular liner 96, which is perforated to allow for the passage of fluid therethrough, from the media pack 84 and into the clean liquid volume 52.

In preferred arrangements, the filter cartridge 28 further includes a valve arrangement 100. The valve arrangement 100 is provided to allow for selected drainage of fluid from the bowl-cartridge filter 24 through the drain port 60 in the filter bowl 26. In the illustrated embodiment, the valve arrangement 100 is mounted to project from the second end 90 of the media pack 84. In the particular embodiment illustrated, the valve arrangement 100 projects from the second end cap 92. In many preferred constructions, the valve arrangement 100 is an integral, and same piece of material as the second end cap 92. In other words, in many preferred arrangements, the valve arrangement 100 is molded with to be the same piece of material as the second cap 92. In still many preferred arrangements, the second end cap 92, valve arrangement 100, and the inner liner 96 are made to be a single-piece construction. In certain, preferred techniques, the second end cap 92, valve arrangement 100, and inner liner 96 are molded, using non-metal parts.

As mentioned above, the filter cartridge 28 includes a first seal member 50 and a second seal member 56. The first seal member 50 is oriented adjacent to the first end cap aperture 88. In the embodiment illustrated, the first end cap 80 includes a projecting seal-holder 104. The seal-holder 104 projects or extends from a remaining portion 106 of the first end cap 80 and defines a groove 108 for holding the first seal member 50. The first seal member 50 presses against the spud 38 to form a first seal 110. The first seal member 50 will be shaped to create the seal 110 with the spud 38. In the embodiment shown, the first seal member 50 is ring-shaped, for example, circular, having a first, outermost dimension. If circular, the first, outermost dimension corresponds to an outer diameter.

The first seal member 50 has a first separation force associated with it. By “separation force”, it is meant the force needed to release the seal 110 formed between the seal member 50 and the sealing surface on the other piece (in this example, the spud 38 on the filter head 22). The separation force is controlled by a number of factors, affecting the gripping action or the friction between the seal member 50 and the sealing surface. Some of these factors include: the dimensions (including diameter and cross-sectional thickness or width) of the seal member 50; the material and properties of the material of the seal member 50; and the material and properties of the sealing surface.

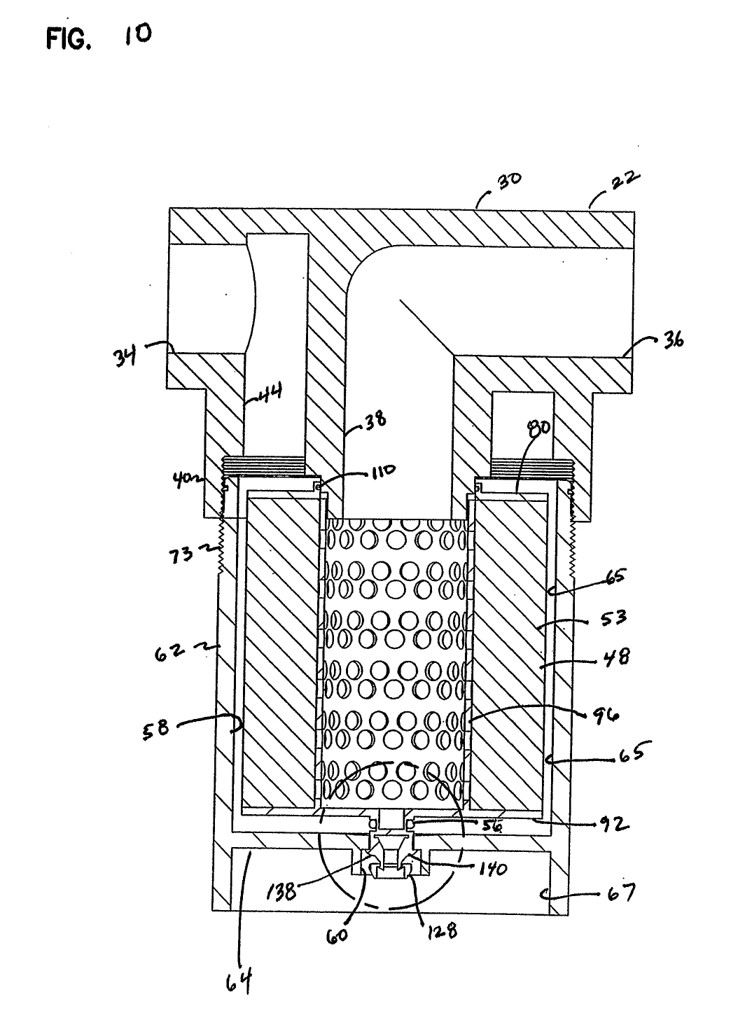

The second seal member 56 is oriented adjacent to the valve arrangement 100. In the embodiment illustrated, the second seal member 56 circumscribes the valve arrangement 100. As can be seen in FIG. 9, the second seal member 56 forms seal 57 between the valve arrangement 100 and an inner sealing surface 112 of the filter bowl 26. The inner sealing surface 112 defines the drain port 60.

The second seal member 56 has a second separation force associated with it. The term “separation force” was defined above and is incorporated by reference here to apply to the second seal member 56.

The second seal member 56 is shaped to create the seal 57 with the inner sealing surface 112. In this example, the second seal member 56 is ring-shaped, preferably, circular. The second seal member 56 defines an outermost dimension, if circular, an outer diameter.

There is a relationship between the first seal member 50 and the second seal member 56. In particular, it is desired that, when servicing the assembly 20, that the seal 57 be released to allow for the drainage of fluid from the filter bowl 26 through the drain port 60, before the seal 110 is released between the filter cartridge 28 and the filter head 22. For example, in general, it is desired to have the first separation force greater than the second separation force. The first separation force, in many example systems, can be just greater than the second separation force by as small as 2%. In preferred systems, the first separation force is greater than the second separation force by 10%-50%. In some systems, the first separation force is at least twice the force of the second separation force.

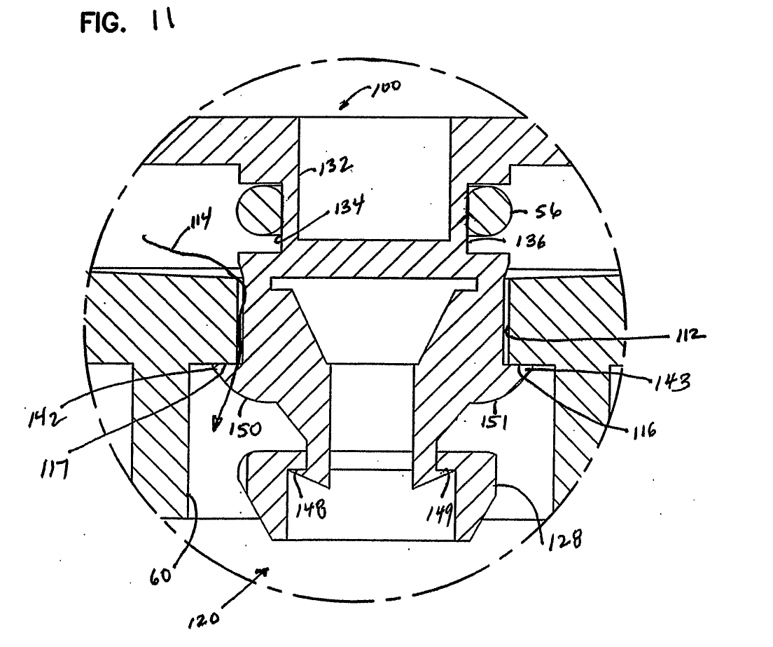

One way of achieving the different separation force between the first separation force and second separation force is through a size difference between the first seal member 50 and second seal member 56. In preferred embodiments, the outermost dimension of the first seal member 50 is constructed to be substantially larger than the outermost dimension of the second seal member 56. This creates more contact area between the first seal member 50, the filter head 22, and the filter cartridge 28, which offers more resistance than the resistance between the second seal member 56, the filter cartridge 28, and the bowl 26. Because of this difference in contact area and resistance, the seal 57 will release before the seal 110. When the seal 57 is released, but the seal 110 is still in place, liquid can be easily drained from the interior volume 58 of the bowl 26 through the drain port 60, while the filter cartridge 28 and filter bowl 26 are still in place and attached to the filter head. An example of this orientation is depicted in FIG. 10. FIG. 11 is an enlarged view of a portion of the cross-section showing the seal 57 released to open a fluid flow path 114 passed the valve arrangement 100 and through the drain port 60.

The differences in outermost dimensions between the first seal member 50 and second seal member 56 can change, depending upon the application. In many preferred arrangements, the outermost dimension of the first seal member 50 is at least 1.5 times the size of the outermost dimension of the second seal member 56. Indeed, in some arrangements, the outermost dimension of the first seal member 50 is twice the size of the second seal member 56. For example, the outermost dimension of the first seal member 50 can have a size of 3-4 inches, while the outermost dimension of the second seal member 56 can have an outermost dimension of 2.0-2.7 inches. In addition, both the geometry and the material of the seal members can be adjusted to achieve the desired differences in separation forces.

The filter cartridge 28 includes structure to aid in the convenient servicing of the filter assembly 20. This includes, for example, the ability to dispose of the filter cartridge 28, without touching the filter media 48. In one example, the filter cartridge 28 includes a release mechanism 120 to allow for selective disengagement of the filter cartridge 28 from the filter bowl 26.

In general, and in reference to FIG. 6, the release mechanism 120 includes a hook construction 122. The hook construction 122, in the specific embodiment shown, is an integral extension from the valve arrangement 100. Of course, this is an example only. The hook construction 122 defines a hooking portion 124 to engage the filter bowl 26, when the filter cartridge 28 is being dismounted from the filter bowl 26 during servicing.

In the particular embodiment illustrated, the hook construction 122 includes a plurality of arms 126. The plurality of arms 126 defines the hooking portion 124. In the preferred embodiment, the plurality of arms 126 are deflectable to allow for selective movement of the hooking portion 124 in a radial direction.

In general, the release mechanism 120 includes a button 128 slidably secured to the hook construction 122. In the embodiment illustrated, the button 128 is mounted to circumscribe the plurality of arms 126. In the arrangement shown, the button 128 is slidable along the plurality of arms 126 to cause radial deflection of the plurality of arms 126.

In arrangements that include the button 128, there is a catch arrangement 130 (FIG. 9) on the plurality of arms 126 to retain the button 128 on the plurality of arms 126. In the particular embodiment illustrated, the valve arrangement 100 includes a neck 132. The neck 132 extends from a remaining portion of the second end cap 92 of the filter cartridge 28. As can be seen, in preferred embodiments, the second seal member 56 circumscribes the neck 132, such that it is oriented to form the seal 57 between the neck 132 and the filter bowl 26, when the filter cartridge 28 is mounted in the filter bowl 26.

In preferred embodiments, the neck 132 defines a groove 134 (FIG. 9) in an outer surface 136 of the neck 132. The second seal member 56 is mounted in the groove 134.

In the illustrated embodiment, the plurality of arms 126 includes at least, a first arm 138 and a second arm 140. More than two arms can be used. In the illustrated embodiment, the first and second arms 138, 140 extends axially from the neck 132. In the particular example embodiment illustrated, each of the arms includes a respective hook member 142, 143. The hook members 142, 143, together, form the hooking portion 124.

In the particular illustrated embodiment, the first arm 138 and second arm 140 each has a free end 146, 147 defining a respective catch member 148, 149. The catch members 148, 149, in the illustrated embodiment, form the catch arrangement 130.

Still in reference to the particular illustrated embodiment in FIG. 9, each of the arms 138, 140, illustrated, has a cam surface 150, 151 between the respective hook member 142, 143 and respective catch member 148, 149. In preferred embodiments, the button 128 is slidable along the cam surface 150, 151. Engagement between the button 148 and the cam surface 150, 151 causes the first and second arms 138, 140 to radially deflect. This radial deflection permits the hooking portion 124 to pass through the drain port 60 and allow the filter cartridge 28 to be removed from the filter bowl 26. The hooking portion 124 is sized to interfere with the perimeter 116 of the drain port 60 of the filter bowl 26 to prevent the filter cartridge 28 from being removed from the filter bowl 26. When the button 128 is slid along the cam surfaces 150, 151, this causes the arms 138, 140 to deflect radially inwardly. The deflection of the arms 138, 140, radially inwardly moves the hook members 142, 143 radially inwardly. This radially, inwardly motion moves the hook members 142, 143 to a position where they no longer interfere with the perimeter 116 of the drain port 60. The entire release mechanism 120 and valve arrangement 100 is then allowed to pass through the drain port 60. This allows for the removal of the filter cartridge 28 from the filter bowl 26.

To service the filter assembly 20, first, the seal 57 between the filter bowl 26 and filter cartridge 28 is released to open the drain port 60 in the filter bowl. This is done by beginning to remove the filter bowl 26 from the filter head 22. In particular, the threaded connection between the filter bowl 26 and filter head 28 is begun to be released by unscrewing the bowl 26 from the head 22. Because of the differences in outermost dimension between the first seal member 50 and second seal member 56, the valve seal 57 releases first.

Next, fluid is drained from the filter bowl 26, through the drain port 60.

Next, after the fluid is drained from the filter bowl 26, the seal 110 between the filter head 22 and filter cartridge 28 is released. This is done by continuing to remove the filter bowl 26 from the filter head 22. For example, this is done by continuing to unscrew the filter head 22 and filter bowl 26.

After the step of releasing the seal 110 between the filter bowl 26 and the filter cartridge 28, a portion of the filter cartridge 28 is engaged against a portion of the filter bowl 26 to prevent axial separation of the filter bowl 26 and the filter cartridge 28. In particular, the hook members 142, 143 catch, engage, or interfere with surface 117 (FIG. 11) forming the perimeter 116 of the drain port 60.

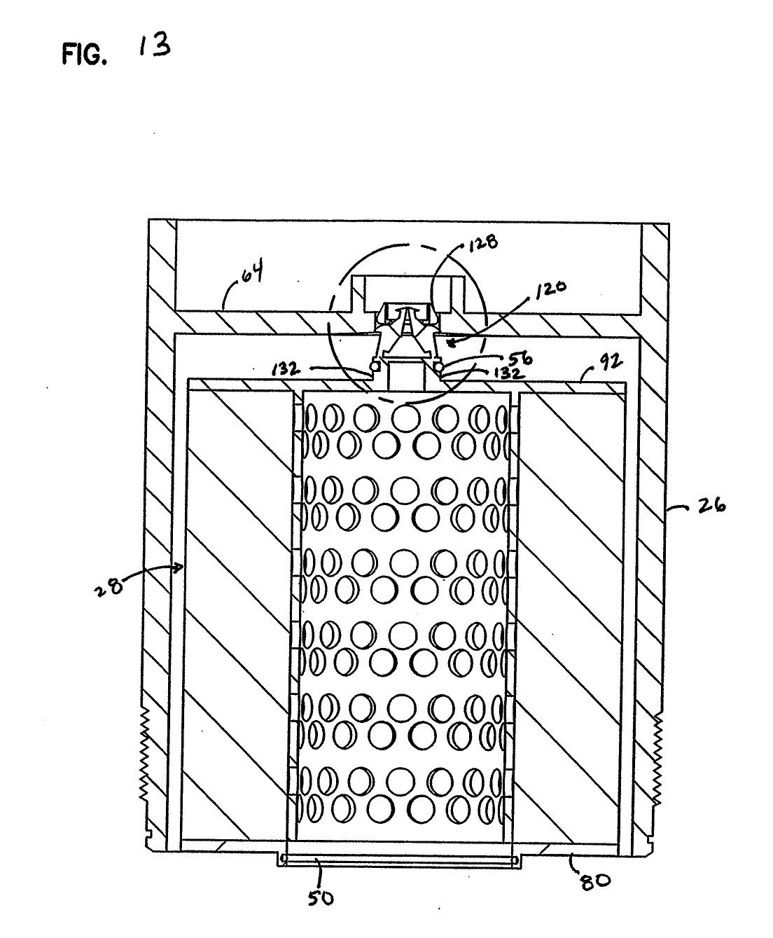

After the step of engaging a portion of the filter cartridge 28 against a portion of the filter bowl 26 to prevent axial separation of the filter bowl 26 and filter cartridge 28, the filter cartridge 28 is disposed of. This can be done by turning the filter bowl (with the filter cartridge 28 still connected thereto at the interface between the hook members 142, 143 and perimeter 116 of drain port 60) upside down. See FIG. 13. By upside down, it is meant that the bottom wall 64 of the filter bowl 28 is oriented over the open mouth 68 of the filter bowl 26. After turning the filter bowl 26 and filter cartridge 28 upside down, the filter cartridge 28 is released from the filter bowl 26.

The step of releasing the filter cartridge 28 from the filter bowl 26 includes pressing the button 128 to release engagement between the filter cartridge 28 and filter bowl 26. For example, in the embodiment shown, the step of pressing the button 128 includes sliding the button 128 along the cam surfaces 150, 151 of the plurality of arms 126 to move the hook members 142, 143 inwardly. This inward motion allows the hook members 142, 143 to get past the perimeter 116 of the drain port 60 and pass through the drain port 60 of the filter bowl 26. Once this structure passes through the drain port 60, there is nothing else holding the filter cartridge 28 in the bowl 26 and the filter cartridge 28 will drop by gravity from the bowl 26.

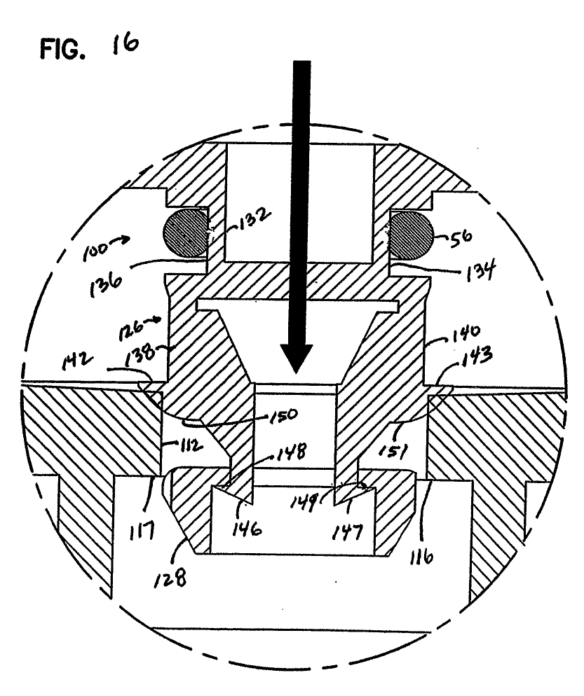

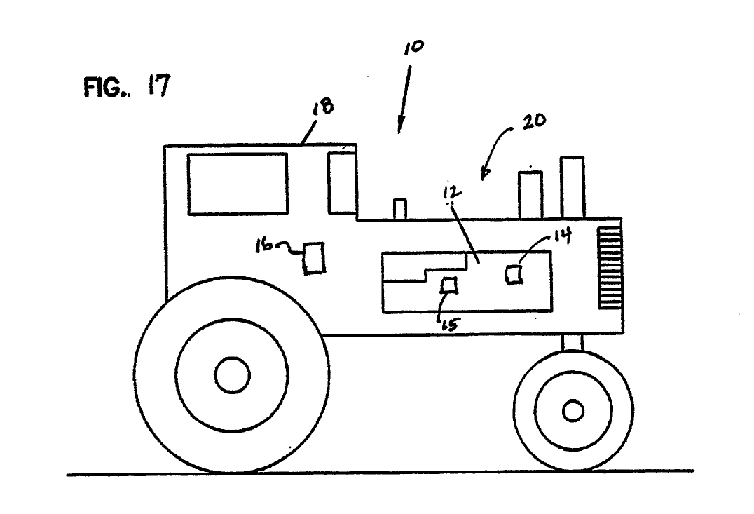

A new, replacement part filter cartridge 28 is then provided. The step of replacing the new filter cartridge 28 into the filter bowl 26 is illustrated in FIGS. 15 and 16. The filter cartridge 28 is inserted through the open mouth 68 of the filter bowl 26. The cam surfaces 150 slide along the inner sealing surface 112 of the drain port 60, to cause radially inward deflection of the arms 126. This allows the entire release mechanism 120, including the arms 126 to pass through the drain port 60. The filter cartridge 28 is continued to be axially placed within the filter bowl 26, until the second seal member 56 is oriented inside of the inner sealing surface 112 to form the seal 57. The bowl-cartridge filter 24, with the new filter cartridge 28, is then operably mounted on the filter head 22 by threading the bowl 26 onto the filter head 22, until the seal 110 between the filter cartridge 28 and filter head 22 is created. There is also created the seal 78 between the filter head 22 and the filter bowl 26. The filter assembly 20 is again ready for filtering operations.

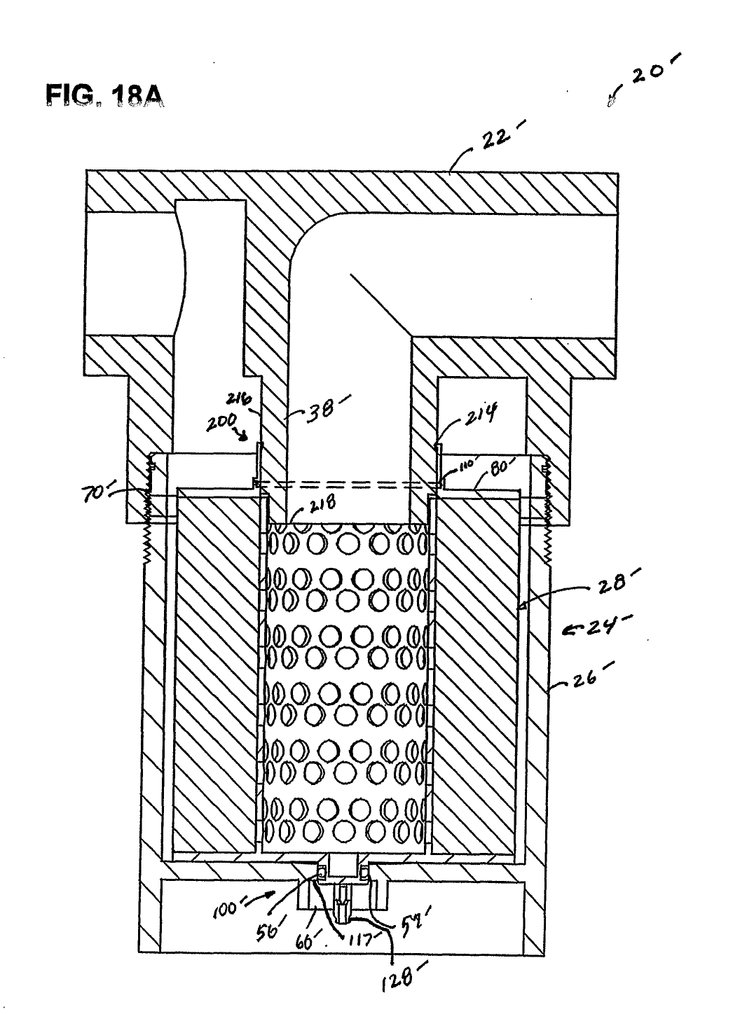

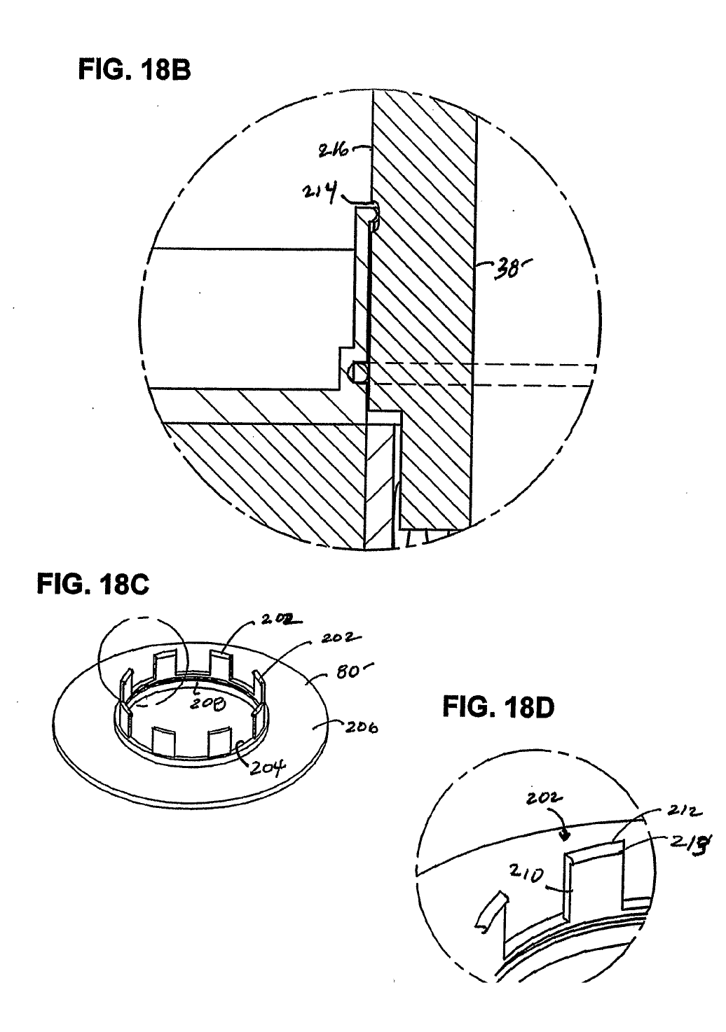

Attention is directed to FIGS. 18A, 18B, 18C, and 18D. A second embodiment of a fluid filter assembly is shown at 20′. In FIG. 18A, the fluid filter assembly 20′ is identical to the fluid filter assembly 20 depicted in FIG. 8, with the exception of the interface between the filter cartridge 28′ and the filter head 22′. In general, in some applications, it may be the case that the relative difference between the diameter of the second seal member 56 and the first seal member 50 (FIG. 8) is negligible, or the coefficient of friction on the larger seal is much lower than that of the smaller seal, or some other case where the force to slide the seals is approximately the same. In those cases, the valve arrangement 100 (FIG. 8) will not separate from the bowl 26, which will prevent the draining function. The embodiment of FIG. 18A addresses these possibilities.

In FIG. 18A, an attachment is established between the first end cap 80′ and the filter head 22′ to require a force between the attachment of the first end cap 80′ and filter head 22′ greater than the force required to separate the bowl 26′ and the seal 57′ between the second seal member 56′ and the bowl 26′.

In the particular embodiment illustrated in FIGS. 18A-18D, a snap-fit arrangement 200 is incorporated into the filter cartridge 28′. Preferably, the snap-fit arrangement 200 is incorporated into the first end cap 80′. The first end cap 80′ defines a plurality of snap tabs 202 (FIG. 18C). As can be seen in FIG. 18C, the snap tabs 202 circumscribe an opening 204 in the first end cap 80′. Snap tabs 202 extend axially from top surface 206 of the end cap 80′ and are spaced to define individual, cantilevered projecting tabs 202. In the embodiment depicted in FIG. 18C, there are eight, individual tabs 202 arranged in a ring along an inner rim 208 of the first end cap 80′.

FIG. 18D shows an enlarged snap tab 202. In FIG. 18D, it can be seen how the snap tab 202 includes an extending finger 210 that extends axially from the top surface 206 and defines a free end 212. The free end 212 defines a hook or catch 213.

In preferred embodiments, the snap tabs 202 are integral with the end cap 80′. In many preferred embodiments, the snap tabs 202 are molded to be the same unitary piece as the end cap 80′.

Part of the snap fit arrangement 202 includes a groove 214 (FIG. 18B) in the filter head 20′. Specifically, the filter head 20′ includes spud 38′, and the groove 214 is defined in the annular or circumferential surface 216 around the outer portion of the spud 38′. Thus, the groove 214, in the embodiment depicted, is in the outer annular surface 216 of the spud 38′.

When the filter cartridge 28′ is positioned in the filter bowl 26′ and the bowl-cartridge filter 24′ is operably attached to the filter head 22′, the catches 213 of the snap tabs 202 engage the groove 214 located circumferentially around the spud 38′.

The snap tabs 202 automatically engage with the groove 214 in the filter head 22′ during normal installation of the bowl-cartridge assembly 24′.

When it is time to service the cartridge 28′, the bowl 26′ is unscrewed from the filter head 22′ by way of the threaded connection 70′. The force required to remove the snap tabs 202 is greater than the force to release the seal 57′ between the seal member 56′ and the bowl 26′. This force to release these snap tabs 202 from the groove 214 needs only be slightly greater than the force to release the seal 57′. In certain preferred arrangements, this force to release the snap fit arrangement 200 is at least 50% greater than the force to release the seal 57′.

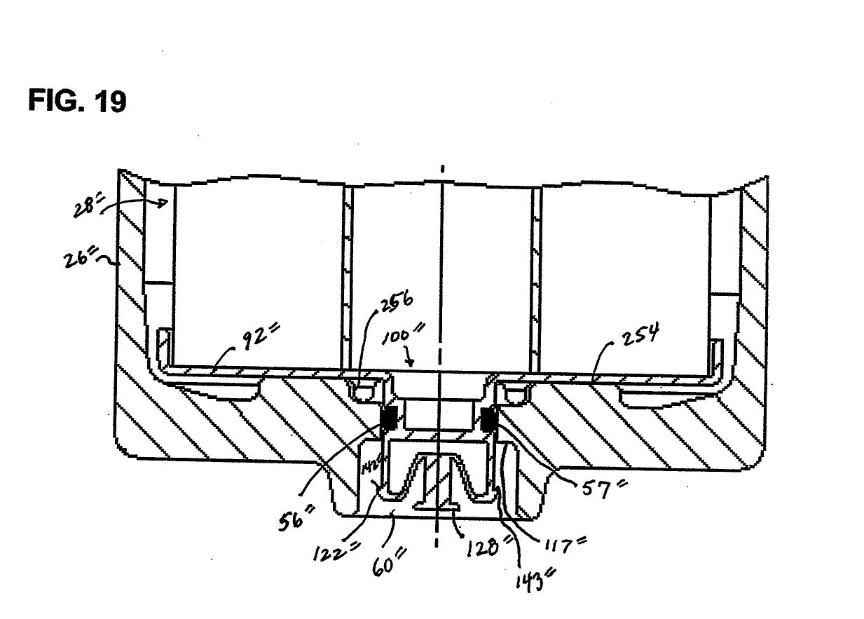

After the seal 57′ is released, the liquid in the bowl-cartridge assembly 24′ is drained through the drain port 60′. Next, after the fluid is drained from the bowl 26′, the cartridge 28′ is released from the filter head 22′ by continuing to remove the filter bowl 26′ from the filter head 22′. This is done by continuing to unscrew the filter head 22′ and the filter bowl 26′. By continuing to unscrew, a portion of the cartridge 28′ is engaged against a portion of the bowl 26′ to prevent axial separation of the bowl 26′ and cartridge 28′. In particular, a pair of hook members 142″, 143″ (see FIG. 19), catch, engage, or interfere with surface 117′ of the drain port 60′. In FIG. 18A, the hook members 142″, 143″ are not visible, because in the view of FIG. 18A, the hook members 142″, 143″ are “into and out of the page”. FIG. 19 shows the same valve arrangement 100″ as valve arrangement 100′ of FIG. 18A. FIG. 19, however, is rotated 90° from the view of FIG. 18A. Thus, in FIG. 19, the hook members 142″, 143″ are visible.

By continuing to unscrew the threaded connection 70′, the connection between the snap tab 202 and the groove 214 is released. That is, the catches 213 are moved outside of the groove 214, and the snap tabs 202 move axially along the spud 38′, until they snap over the free end 218 (FIG. 18A) of the spud 38′.

The cartridge 28′ is then released from the filter bowl 26′. The button 128′ is pressed to release engagement between the cartridge 28′ and bowl 26′.

It is noted that in the embodiment of FIG. 18A, typically the snap fit arrangement 200 will be designed to release from the filter head 22′ before the threaded connection 70′ is completely released. This ensures that the filter cartridge 28′ will not remain connected to the filter head 22′ after the bowl 26′ is completely disconnected from the head 22′.

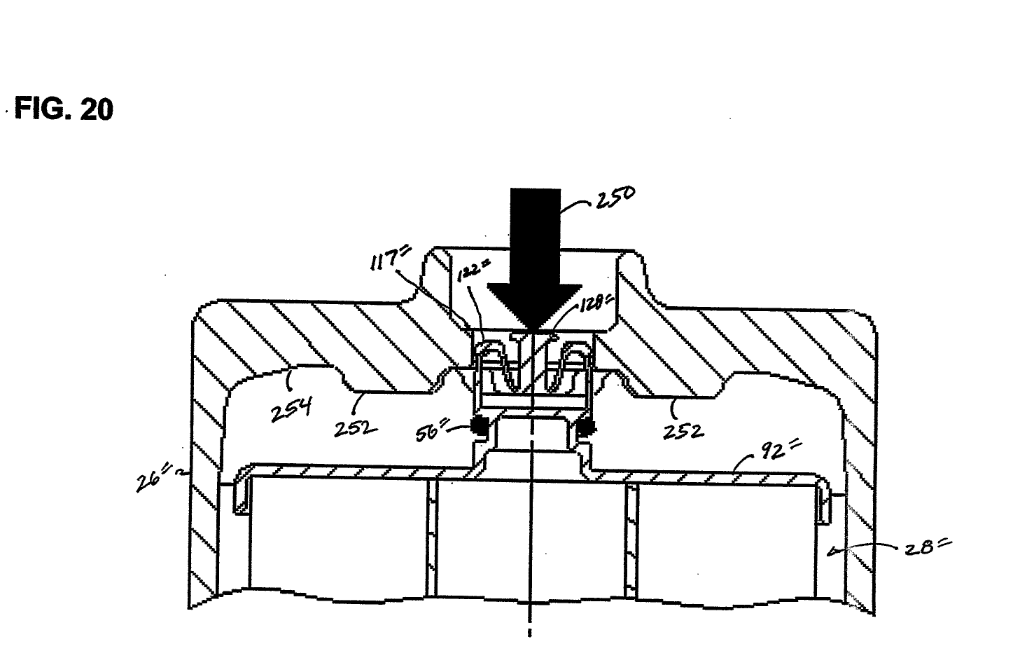

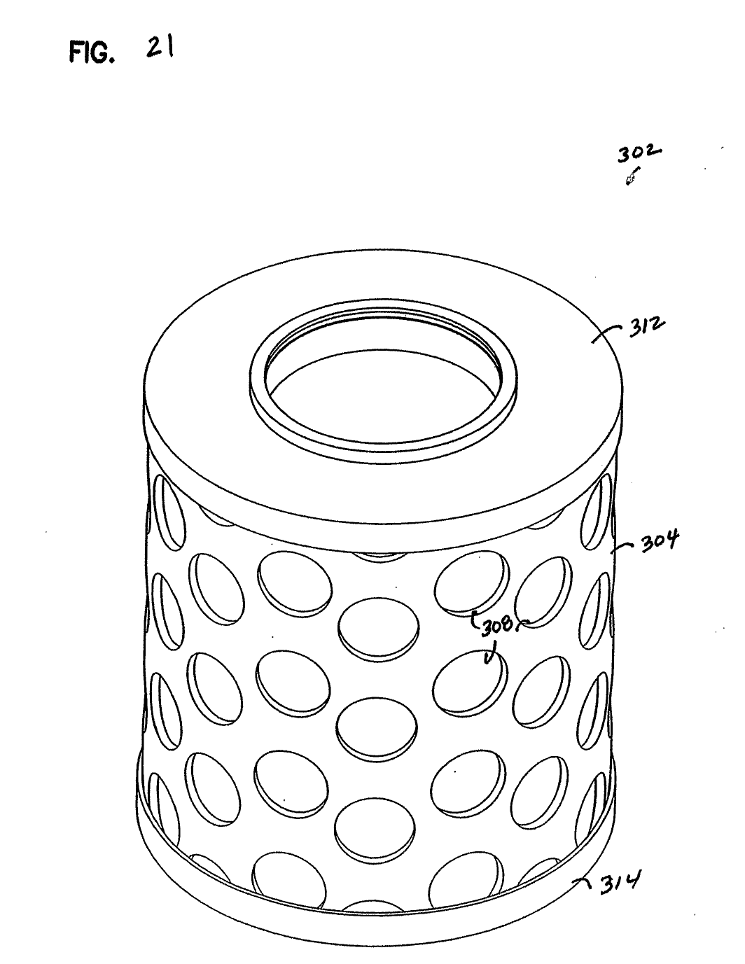

Attention is next directed to the embodiment of FIGS. 19 and 20. In the embodiments of FIGS. 19 and 20, the button 128 (FIG. 11) is integrated into the valve arrangement 100. In FIG. 19, the valve arrangement 100″ includes a button 128″ integrated into an integral end cap 92″. Preferably, the end cap 92″ is a molded, unitary, same piece of material as the valve arrangement 100″ and the button 128″. The seal 57″ can be seen created between the seal member 56″ and the filter bowl 26″. As explained above, the valve arrangement 100″ is also the same valve arrangement depicted in FIG. 18A at 100′.

FIG. 20 shows the filter cartridge 28″ during removal from the bowl 26″. The arrow 250 represents the force being applied to the button 128″ to move the hooking construction 122″ (and hook members 142″, 143″) radially inwardly in order to clear the surface 117″, allowing separation of the cartridge 28′ from the bowl 26′.

FIGS. 19 and 20 further show an additional feature. The bowl 26″ in the embodiment of FIGS. 19 and 20 includes bumps 252 along an inner, bottom, bowl surface 254. The bumps 252 create a larger flow path or a funnel surface 256 toward the drain port 60″.

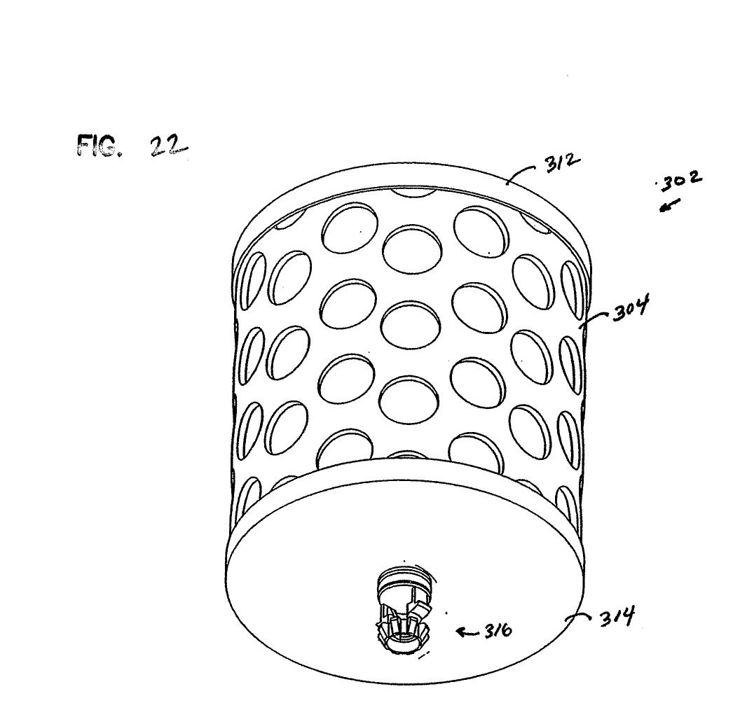

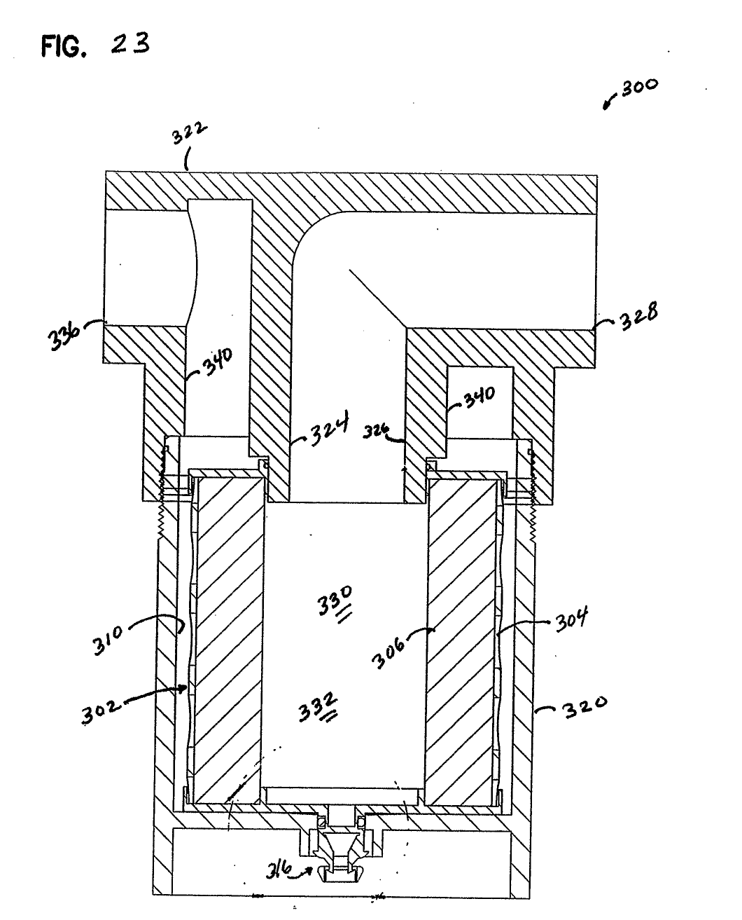

Attention is now directed to FIGS. 21-23. The fluid filter assembly arranged for a reverse flow system is depicted at 300 (FIG. 23). FIGS. 21 and 22 show a filter cartridge 302 useable in the reverse flow filter assembly 300. The filter cartridge 302 includes structure analogous to the filter cartridge 28 of FIG. 4, but in the filter cartridge 302 of FIGS. 21 and 22, there is no inner liner 96. Instead, there is an outer liner 304. The outer liner 304 functions to support the filter media 306. The outer liner 304 is porous, having apertures 308. The apertures 308 allow fluid to pass from the filter media 306 through the apertures 308 to a clean liquid volume 310 (FIG. 23) outside of the filter cartridge 302. In other embodiments, instead of an outer liner 304, there is an outer roving to support the filter media 306.

The filter cartridge 302 includes a first end cap 312, a second end cap 314, and a valve arrangement 316. In general, the valve arrangement 316 is the same valve arrangement 100 described in connection with the first embodiment.

FIG. 23 depicts the filter cartridge 302 installed within a filter bowl 320 and operably assembled on a filter head 322. The filter cartridge 302 installs and is mounted identical to the manner described with respect to the first embodiment. FIG. 23, in contrast to the first embodiment, however, shows a reverse flow system. As a reverse flow system, the spud 324 defines an inlet channel 326. An inlet port 328 is defined by the filter head and is in fluid communication with the inlet channel 326. The inlet channel 326 is in open, fluid communication with an open filter interior 330. The open filter 330 is the internal volume that is circumscribed by the tubular section of pleated media 306. In this embodiment, the open filter interior 330 also corresponds to an unfiltered liquid volume 332.

The filter head 322 also includes an outlet port 336. The outlet port 336 is in fluid communication with an outlet channel 340. The outlet channel 340 is in fluid communication with the cleaned liquid volume 310.

Operation of the reverse flow filter assembly 300 can now be understood. Fluid to be cleaned flows into the filter head 322 through the inlet port 328, along the inlet channel 326, and then into the unfiltered liquid volume 332. From there, the fluid flows through the filter media 306, through the holes 308 in the outer liner 304, and into the clean liquid volume 310. From there, the cleaned liquid flows through the outlet channel 340 and then exits the filter head 322 through the outlet port 336.

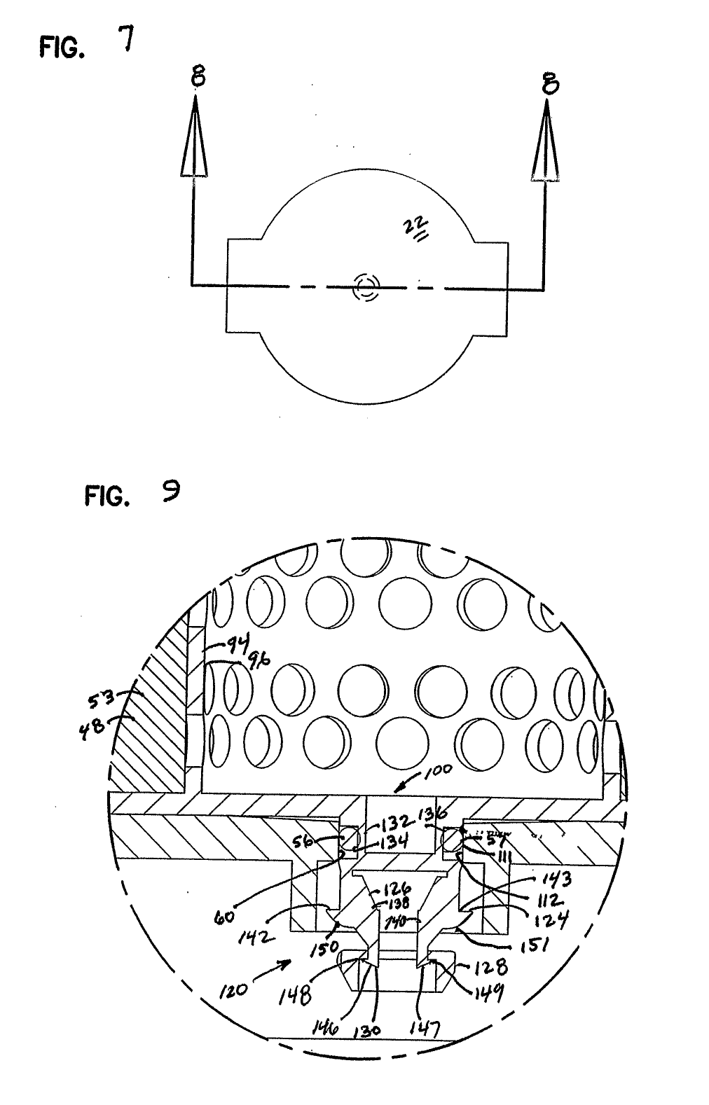

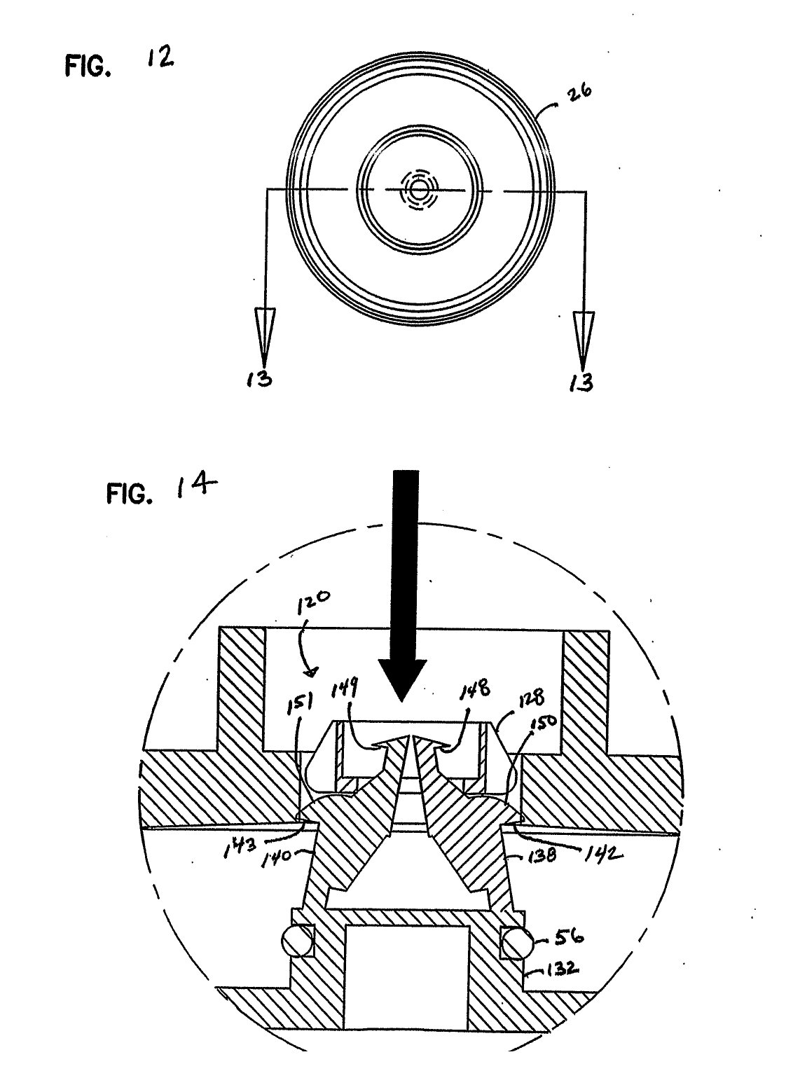

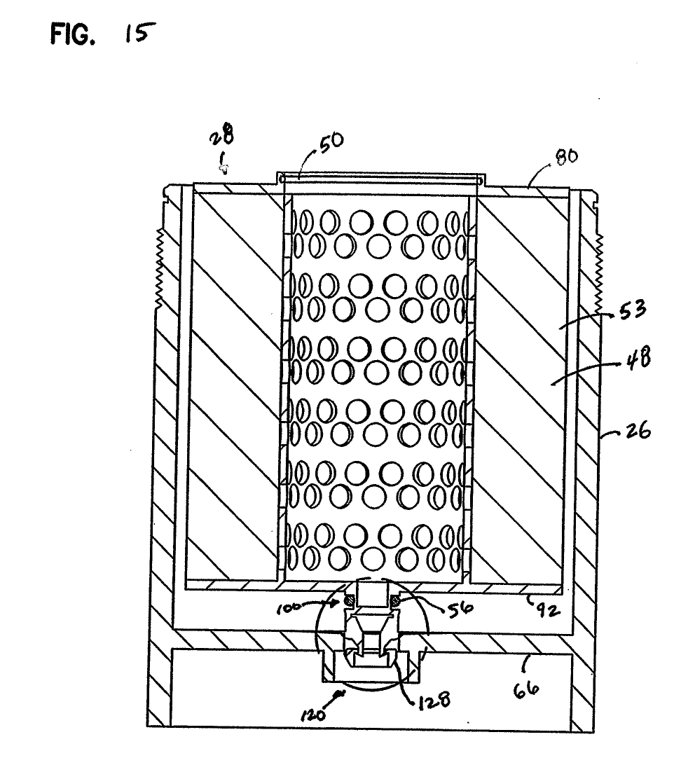

The valve 316 operates in the same manner as described with respect to FIGS. 1-16.

FIG. 24 depicts another embodiment of a fluid filter assembly at 400. The fluid filter assembly includes a filter cartridge 402 and a filter head 404. Only a portion of the fluid filter assembly 400 is depicted, as the connection between the filter cartridge 402 and filter head 404 is understood to be any one of the various connections described above showing respective engagement or connection between cartridges and filter heads.

The filter cartridge 402 includes structure analogous to the filter cartridge 28 of FIG. 4, but in the filter cartridge 402 of FIG. 24, there is no inner liner 96. In addition, there is no outer liner. There is a tubular structure of filter media 406 including a roving 408 circumscribing and supporting the filter media 406.

The filter cartridge 402 includes a first end cap 412, a second end cap 414, and a valve arrangement 416. The valve arrangement 416 is somewhat different from the embodiments described above. More details on the valve arrangement 416 are described below.

The filter cartridge 402 is shown as installed within a filter bowl 420 and operably installed on filter head 404.

The valve 416, in the embodiment shown in FIG. 24, includes a neck 421 extending into the open interior volume 422 of the tubular media pack 406. The neck 421 has an interior volume side 424 and an opposite housing engaging side 426. The interior volume side 424 is in immediate communication with the open interior volume 422. The housing engaging side 426 is adjacent to and in immediate contact with the filter bowl 420. The neck 421 includes a radial surface 428 on the housing engaging side 426. A second seal member 430 is mounted on the radial surface 428 to form a radial seal 432 between the neck 421 and the filter bowl 420. The neck 421 defines a groove 434 in the radial surface 428, which holds the seal member 430. In the embodiment shown, the seal member 430 is depicted as an O-ring.

In FIG. 24, the neck 421 is shown projecting inwardly, into the open filter interior 422, from a remaining part 440 of the end cap 414. The filter bowl 420 has a tubular side wall 442 defining an interior volume 444, an open mouth 446 in communication with the interior volume 444, and a drain port 448 in communication with the interior volume 444.

The valve arrangement 416, in the embodiment shown, extends through the filter bowl drain port 448. The second seal member 430 forms seal 432 between the filter bowl 420 and the filter cartridge 402. The seal 432 blocks fluid flow from the interior volume 444 of the filter bowl 420 through the drain port 448.

The bowl 420 includes an outwardly extending wall 450 circumscribing the drain port 448. In this embodiment, there is also an inwardly extending wall 452, which projects into the interior volume 444 of the filter bowl 420. The wall 452 and wall 450 are continuous, and define the drain port 448.

Extending from the neck 421 is a cap section 456. The cap section 456 rests over the end of the inner wall 452, and includes a recessed bowl 458 covering an open end of the drain port 448, as defined by the end of the inner wall 452. The combination of the seal 432 and cap section 456 contribute to blocking fluid flow from the interior volume 444 of the filter bowl 420 through the drain port 448.

The connection of the filter cartridge 402 to the filter head 404, as mentioned earlier, can be a connection as shown and described in FIG. 8, or in FIG. 18a, or in FIG. 23. The discussion of each of those connections is incorporated herein by reference.

1-48. (canceled)

49. A filter cartridge comprising:
(a) a tubular media pack including a region of filter media surrounding an open interior volume; the media pack having a first end and an opposite second end;
(b) a first end cap adjacent to the first end of the media pack; the first end cap defining a first end cap aperture in communication with the open interior volume;
(c) a first seal member adjacent to the first end cap aperture;
(i) the first seal member having a first separation force;
(d) a second end cap adjacent to the second end of the media pack;
(e) a second seal member adjacent to the second end cap;
(i) the second seal member having a second separation force; and
(ii) the first separation force being greater than the second separation force.

50. A filter cartridge according to claim 49 further including:
(a) a valve arrangement mounted to project from the second end of the media pack.

51. A filter cartridge according to claim 50 wherein:
(a) the second end cap includes a neck;
(i) the neck including an interior volume side and an opposite housing engaging side;
(ii) the neck including a radial surface on the housing engaging side; and
(iii) the second seal member being oriented on the radial surface.

52. A filter cartridge according to claim 50 further including:
(a) a release mechanism; the release mechanism including a hook construction; the hook construction defining a hooking portion to engage a filter bowl, when the filter cartridge has been mounted in a filter bowl and is being dismounted from the filter bowl.

53. A filter cartridge according to claim 52 wherein:
(a) the hook construction includes a plurality of arms; the plurality of arms defining the hooking portion;
(i) the plurality of arms being deflectable to allow selective movement of the hooking portion in a radial direction.

54. A filter cartridge according to claim 53 wherein:
(a) the release mechanism includes a button slidably secured to the hook construction;
(i) the button being mounted to circumscribe the plurality of arms;
(ii) the button being slidable along the plurality of arms to cause radial deflection of the plurality of arms.

55. A filter cartridge according to claim 50 wherein:
(a) the valve arrangement includes a neck.

56. A filter cartridge according to claim 55 wherein:
(a) the second seal member is circumscribing the neck and is oriented to form a seal between the neck and a filter bowl, when the filter cartridge is mounted in a filter bowl.

57. A filter cartridge according to claim 56 wherein:
(a) the neck is circumscribed by the tubular media pack;
(i) the neck including an interior volume side and an opposite housing engaging side;
(ii) the neck including a radial surface on the housing engaging side; and
(iii) the second seal member being oriented on the radial surface.

58. A filter cartridge according to claim 50 wherein:
(a) the valve arrangement and second end cap are a single, integral piece.

59. A filter cartridge according to claim 58 further including:
(a) a release mechanism to engage a filter bowl, when the filter cartridge has been mounted in a filter bowl and is being dismounted from the filter bowl;
(i) the release mechanism being a single, integral piece with the valve arrangement and the second end cap.

60. A filter cartridge according to claim 50 further comprising:
(a) an inner liner circumscribed by the region of filter media.

61. A filter cartridge according to claim 60 wherein:
(a) the valve arrangement, the second end cap, and the inner liner are a single, integral piece.

62. A filter cartridge according to claim 49 wherein:
(a) the first seal member has a first outermost dimension; and
(b) the second seal member has a second outermost dimension;
(i) the first outermost dimension being at least twice the size of the second outermost dimension.

63. A filter cartridge according to claim 49 wherein:
(a) the second end cap includes a neck;
(i) the neck including an interior volume side and an opposite housing engaging side;
(ii) the neck including a radial surface on the housing engaging side; and
(iii) the second seal member being oriented on the radial surface.

64. A filter cartridge according to claim 49 wherein:
(a) the first seal member has a first outermost dimension; and
(b) the second seal member has a second outermost dimension;
(i) the first outermost dimension being at least 1.5 times the size of the second outermost dimension.

65. A filter cartridge according to claim 49 wherein:
(a) the first seal member has a first outermost dimension;
(i) the first outermost dimension has a size of 1.0-2.0 inches; and
(b) the second seal member has a second outermost dimension;
(ii) the second outermost dimension has a size of 0.7-1.3 inches.

66. A filter cartridge according to claim 49 further including:
(a) a snap fit arrangement extending from the filter cartridge and being constructed and arranged to engage a filter head.

67. A filter assembly comprising:
(a) a filter cartridge including:
(i) a tubular media pack including a region of filter media surrounding an open interior volume; the media pack having a first end and an opposite second end;
(ii) a first end cap adjacent to the first end of the media pack; the first end cap defining a first end cap aperture in communication with the open interior volume;
(iii) a first seal member adjacent to the first end cap aperture; the first seal member having a first separation force;
(iv) a second end cap adjacent to the second end of the media pack;
(v) a second seal member adjacent to the second end cap; the second seal member having a second separation force; and the first separation force being greater than the second separation force; and
(b) a filter bowl having a tubular sidewall defining an interior volume; an open mouth in communication with the interior volume; the filter cartridge being removable and replaceable in the interior volume of the filter bowl;
(i) the filter bowl including a drain port in communication with the interior volume;
(ii) the filter cartridge further includes a valve arrangement mounted adjacent to the second end of the media pack;
(A) the second seal member being adjacent to the valve arrangement;
(B) the valve arrangement extending through the filter bowl drain port;
(C) the second seal member forming a seal between the filter bowl and the filter cartridge;
wherein the seal blocks fluid flow from the interior volume of the filter bowl through the drain port.

68. A method of servicing a filter assembly; the method comprising:
(a) removing the filter bowl from a filter head to, first, release a seal between the filter bowl and the filter cartridge to open a drain port in the filter bowl;
(b) draining fluid from the filter bowl through the drain port; and
(c) continuing to remove the filter bowl from the filter head to, second, release a seal between the filter cartridge and the filter head.
